(19) United States
(12) Patent Application Publication
(10) Pub. No.: US 2006/0159505 A1
(43) Pub. Date: Jul. 20, 2006

(54) Ribbon packaging and loading device

(76) Inventor: Robert Holmberg, Lerum (SE)

Correspondence Address: Orum & Roth LLC, Ste 1616, 53 W Jackson Blvd, Chicago, IL, 60604, US

(21) Appl. No.: 11/299,574

(22) Filed: Dec. 12, 2005

Related U.S. Application Data
(60) Provisional application No. 60/635,389, filed on Dec. 10, 2004.

(51) Int. Cl. B41J 35/28

(52) U.S. Cl. 400/207

(57) ABSTRACT

Ribbon packaging is used to load the ribbon into the printer and to code the media type into the printer. The inventive ribbon packaging comprises a contoured sleeve that acts as a loading device. The contoured sleeve with printer ribbon is inserted into the printer. The contoured sleeve is withdrawn and the printer ribbon is left in the installed position in the printer. The packaging also has coding that can be read by the printer's electronics and coded in to the printer software, thereby automatically setting up the media type.

This application claims the benefit of U.S. Provisional Application No. 60/635,389 filed 10 Dec. 2004 and entitled Ribbon Packaging and Loading Device.

### FIELD OF THE INVENTION

1. Background of the Invention

The present invention relates to packaging. More particularly, it relates to printer ribbon packaging with integrated media set-up coding.

2. Description of the Prior Act

Manual loading of prior art printer ribbon is cumbersome. Prior art printer ribbon is either manually loaded onto the printer or a ribbon cassette is manually loaded into the printer. After the ribbon is loaded, a technician manually enters the media settings. This requires the technician to progress through numerous menus. There is a need for an easier method of loading ribbon and entering the media settings.

Printers utilizing ribbon cassettes require specific cassette configurations which often restricts the user to one brand of ribbon. In addition a ribbon cassettes are expensive and environmentally unfriendly. Thus, there are disincentives for users to buy ribbon cassette printers. There is a need for an efficient, low cost, environmentally friendly printer media that does not require manual adjustment of the media settings.

### SUMMARY OF THE INVENTION

The inventive ribbon packaging is used to load the ribbon into the printer and to code the media type into the printer. This addresses the cumbersome tasks of loading ribbon into the printer and setting the media settings.

The inventive ribbon packaging comprises packaging that is shaped as a loading device. Preferably, the shape of the packaging is adapted to be used in the particular printer. The packaging also has some form of coding mechanism that can be read by the printer's electronics and coded thereby automatically setting up the media type. Preferably, there is a bar code, RFID, a matrix of lights, a matrix of switches or other coding pattern on the packaging that is read by or scanned by the when the media is installed. Preferably, the packaging is manufactured of cardboard paper and wrapped with plastic foil.

### BRIEF DESCRIPTION OF THE DRAWINGS

FIG. 1 is a view of a wrapped printer ribbon.

FIG. 2 is a printer ribbon-loading device.

FIG. 3 is a printer ribbon after it has been removed from the loading device.

FIG. 4 is a view of the printer ribbon-loading device in an unfolded state.

FIG. 5 is an alternate embodiment of a wrapped printer ribbon.

FIG. 6 is an alternative embodiment of the printer ribbon with the loading device cassette.

### DETAILED DESCRIPTION OF THE INVENTION

An easy loadable and configurable printer ribbon. The printer packaging is configured as a loading device. The ribbon comes packaged in a shaped loading device.

The inventive ribbon packaging is used to load the ribbon into the printer and to code the media type into the printer. This reduces the time needed to perform the tasks of loading ribbon into the printer and setting the media settings.

The inventive ribbon packaging comprises an outer wrap 34 and a contoured sleeve 32 that is configured as a loading device. Outer wrap 34 is preferably manufactured of plastic or foil. If outer wrap is a plastic or foil, it may have an opening strip 38 that can be pulled and cut the foil or plastic allowing a portion to separate or detached. Outer wrap 34 can be removed in other ways such as by unfolding, tear, cutting, etc. The shape of the contoured sleeve 32 is determined by a selected printer.

Packaging also has coding 36 that can be read by the printer's electronics. Coding 36 can be on contoured sleeve 32, ribbon hub 10, 12 or outer wrap 34. The printer software automatically adjusts the settings based on the information about the media type and optimal printer settings that is stored in the coding 36. Preferably, coding 36 is a bar code, RFID, or other symbology, indicia or pattern on the contoured sleeve 32 or outer wrap 34 that can be read by or scanned by the printer each time the printer ribbon is replaced. Optionally, coding can be a matrix or pattern of lights that are read by a light sensor, a series of switches, a series of contacts that connect with corresponding series of switches in the printer, a combination of coding matrixes or patterns or any know type of coding or mechanism to set the printer settings. The information coded into the coding means is media information which automatically sets the media settings of the printer.

The inventive packaging is a contoured sleeve 32 that serves as a loading device. Preferably, the contoured sleeve 32 is made of folded cardboard, card stock or other sturdy recyclable material for environmental reasons. However, many different materials could be used. At least one end 42 of contoured sleeve 32 is open. Second end 44 of contoured sleeve can be open or can be covered with panel 46. Panel 46 is to make outer dimensions uniform for easier packaging the in outer wrap 34 and for easier packing of the ribbon in shipping container.

Contoured sleeve 32 has a ribbon sleeve 48, a take up sleeve 50 and a positioning sleeve 52. The dimensions of ribbon sleeve 48, take up sleeve 50 and positioning sleeve 52 are based on the specific printer for which ribbon 10 is to be place. Contoured sleeve 32 is shaped such that a user can insert sleeve 32 into printer 20 and the ribbon 10 will load into printer at the correct position. Ribbon sleeve 48 is dimensioned to hold the ribbon 10 and ribbon hub 12, take-up sleeve 50 is dimensioned to hold take up hub 14. Preferably, some ribbon extends from the ribbon hub 12 to take-up hub 14. Ribbon sleeve 48 and take-up sleeve 50 are positioned relative to each other such that when contoured sleeve 32 is place in the printer, ribbon hub 12 is installed on the ribbon device and take-up hub is installed on take up device. Positioning sleeve 52 is a portion of contoured sleeve that together with ribbon sleeve and take up sleeve dimensioned to fit into the printer in-only one way. Positioning sleeve is positioned relative to ribbon sleeve 48 and take up sleeve 50 such that when contoured sleeve 32 is placed in printer, ribbon is loaded in the correct position. Contoured sleeve may include additional contours. For example, there may be a ribbon path contour to ensure that ribbon between the unwind hub 12 and take up hub 14 is properly aligned in the printer. In other printers it may not be necessary to have positioning sleeve 52, as ribbon sleeve 48 and take up sleeve 50 may allow contoured sleeve 32 to fit into printer in only one way and to install the ribbon and take up hub. In other printers it may not be necessary to install a take-up hub 12 and thus, the contoured sleeve may not include take up sleeve 52.

Optionally, panel 46 may ensure that ribbon 10 is installed at the correct distance on the spindle by preventing the contoured sleeve 32 from being inserted too far into the printer.

Contoured sleeve 32 is removed from the printer leaving ribbon 10 in the loaded position. Contoured sleeve 32 comes prepackaged with ribbon 10. The configuration of sleeve 32 and ribbon depends on the specific printer.

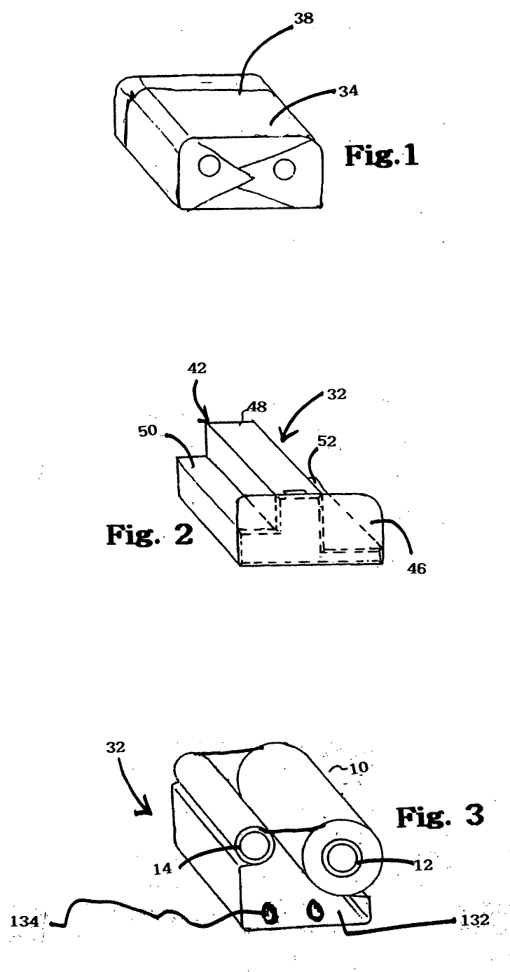

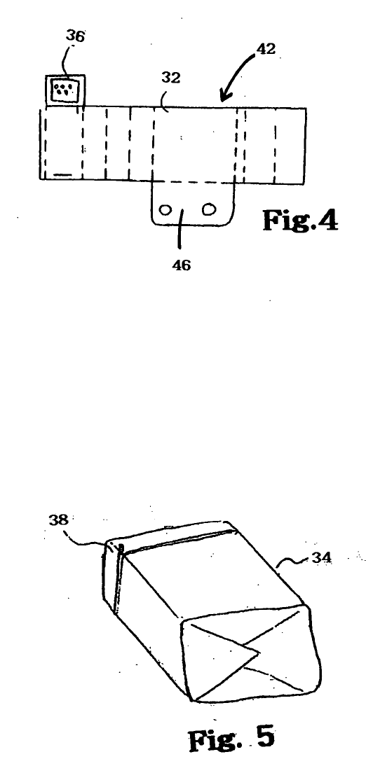

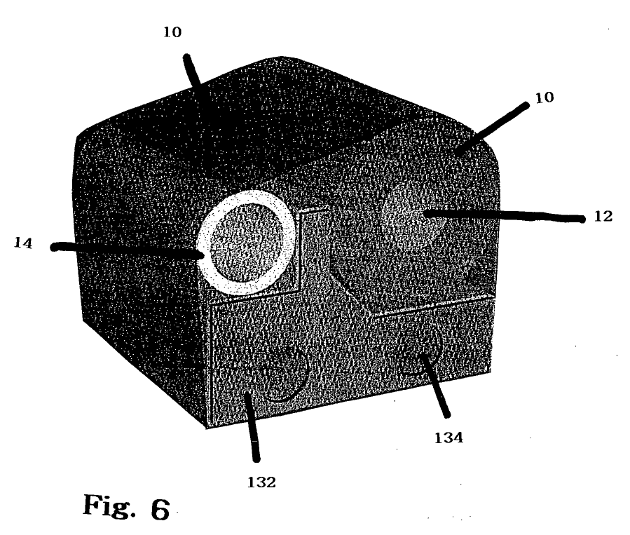

In one embodiment, shown in FIGS. 1-3, printer ribbon 10 has an unwind hub 12 and a rewind hub 14. Unwind hub 12 needs to be loaded on unwind spindle and rewind hub 14 is loaded on rewind spindle of printer.

Contoured sleeve comprises at least one piece of cardboard or other material that has been folded or formed into a shape that will hold the ribbon and the ribbon take-up roll and allow it to be loaded into the printer. The outer layer of packaging is relatively thin. In one embodiment, outer wrap 32 is plastic wrapping foil.

The appropriate ribbon for the printer is selected. User removes the outer wrap 34 by pulling an opening strip 38. Contoured sleeve 32 with the coding 36 is removed from outer wrap 36. Printer ribbon 10 and take-up roll 14 are inside contoured sleeve 32. Contoured sleeve 32 allows ribbon 10 to be loaded into the printer quickly and easily. Contoured sleeve 32 is inserted into the printer. The shape of the contoured sleeve is such that as contoured sleeve 32 is inserted into the printer, ribbon 10 is loaded at the appropriate location. Preferably, contoured sleeve 32 is withdrawn from the printer once ribbon 10 has been loaded. Coding 36 is scanned or interrogated before the ribbon is loaded, just after the media is loaded or as the ribbon is being loaded in the printer. Information in coding 36 provided media data and optimal printer setting data to the printer. Software in the printer automatically sets the printer settings. Because contoured sleeve 32 is preferably made of cardboard it is environmentally friendly.

In an alternative embodiment, ribbon 10 and rewind hub 12 are positioned on the outside of contoured sleeve. Contoured sleeve may have apertures, grooves, or positioning sleeve to ensure proper placement in the printer. Contoured sleeve is removed after the ribbon is loaded.

In an alternative embodiment, user may obtain the appropriate contoured sleeve 32 for his printer. User inserts printer ribbon 10 or other media and the take up hub into contoured sleeve 32 before loading the media into the printer. Contoured sleeve 32 fits into printer in only one way and is used to guide the loading of the printer. Contoured sleeve 32 may be package flat and folded into the desired shape by the user. Contoured sleeve 32 may be scored at the folds to make it easier for the user.

Coding 36 is read or scanned and the media settings are automatically provided to the printer software. A scanner or interrogator attached to the printer can be used to scan the settings. Alternatively, the printer may have a built in scanner to scan coding 36 as the contoured sleeve 32 is in the loading position.

In another alternative, loading device is a cassette 132 that remains in the printer until it is time to replace ribbon 10. Cassette 132 is shaped to match the printer. Ribbon cassette 132 is made of cardboard or another sturdy recyclable material. Ribbon cassette 132 may optionally have apertures 134, grooves or other elements to load cassette into the printed in an installed position.

1. A loading device for a printer comprising:
a contoured sleeve,
a ribbon roll on an unwind hub in the contoured sleeve, and
a ribbon rewind hub in the contoured sleeve,
wherein the contoured sleeve is dimensioned to fit in a printer in only one position.

2. The loading device of claim 1 wherein the contoured sleeve comprises a ribbon sleeve housing the ribbon roll and a rewind sleeve housing the ribbon rewind hub, said ribbon sleeve and said rewind sleeve positioned

3. The loading device of claim 2 wherein the ribbon roll is installed on a ribbon spindle of the printer and the rewind hub is installed on a rewind spindle of the printer when the contoured sleeve is fit in the printer in the one position.

4. The loading device of claim 2 further comprising a positioning sleeve.

5. The loading device of claim 2 wherein a first end of the ribbon roll is attached to the rewind hub.

6. The loading device of claim 5 further comprising a ribbon contour portion, said ribbon contour portion aligns the ribbon between the ribbon roll and the ribbon hub.

7. The loading device of claim 2 further comprising coding containing media and/or printer setting data.

8. The loading device of claim 7 wherein the coding is a bar code and/or an RFID tag.

9. The loading device of claim 1 further comprising an outer wrap surrounding the contoured sleeve.

10. The loading device of claim 1 wherein the contoured sleeve is formed from a single piece of folded material.

11. The loading device of claim 9 wherein the contoured sleeve further comprises a first end for insertion into a printer and a panel covering a second end.

12. A loading device for a printer comprising:
a contoured sleeve dimensioned to fit in a printer in only one position;
said contoured sleeve comprising a ribbon sleeve and a rewind hub sleeve, said ribbon sleeve and said take-up sleeve positioned relative to each other such that when the contoured sleeve is placed in the printer the ribbon sleeve is located over a ribbon spindle and the rewind sleeve is located over a rewind spindle.

13. The loading device of claim 12 wherein the contoured sleeve is formed from a single piece of folded material.

14. The loading device of claim 12 wherein the material is cardboard, further comprising scoring at the positions of the folds and an adhesive on an edge of the cardboard to retain the shape of the contoured sleeve.

15. A loading device for a printer comprising A loading device for
a printer comprising:
a contoured sleeve,
a ribbon roll on an unwind hub and
a ribbon rewind hub, said ribbon roll and said ribbon rewind hub positioned on the contoured sleeve,
wherein the contoured sleeve is dimensioned to fit in a printer in only one position.

16. The loading device of claim 15 wherein the ribbon roll is installed on a ribbon spindle of the printer and the rewind hub is installed on a rewind spindle of the printer when the contoured sleeve is fit in the printer in the one position.

17. The loading device of claim 16 wherein a first end of the ribbon roll is attached to the rewind hub.

18. The loading device of claim 16 further comprising coding containing media and/or printer setting data.

19. The loading device of claim 18 wherein the coding is a bar code and/or an RFID tag.

20. The loading device of claim 16 further comprising an outer wrap surrounding the contoured sleeve.
